(19) United States
(12) Patent Application Publication
(10) Pub. No.: US 2026/0369234 A1
(43) Pub. Date: Nov. 19, 2026

(54) Method for Driving Display Apparatus, Display Apparatus, and Display Device

(71) Applicant: HUAWEI TECHNOLOGIES CO., LTD., Shenzhen (CN)

(72) Inventors: Cang Liu, Dongguan (CN); Shixiong Zhang, Dongguan (CN); Qiangcan Huang, Dongguan (CN); Shuyi Lei, Dongguan (CN); Wei Bai, Dongguan (CN)

(73) Assignee: HUAWEI TECHNOLOGIES CO., LTD., Shenzhen (CN)

(21) Appl. No.: 19/734,917

(22) Filed: Jul. 8, 2026

Related U.S. Application Data
(63) Continuation of application No. PCT/CN2024/144125, filed on Dec. 31, 2024.

(30) Foreign Application Priority Data
Mar. 8, 2024 (CN) 202410281526.5

(51) Int. Cl. G09G 3/3266; G09G 3/3233

(52) U.S. Cl. CPC G09G 3/3266; G09G 3/3233; G09G 2300/0819; G09G 2300/0842; G09G 2310/0286; G09G 2310/08; G09G 2320/0247; G09G 2320/041; G09G 2330/021; G09G 2340/0435

(57) ABSTRACT

A method for driving a display apparatus includes obtaining status information of the display apparatus, where the status information includes display brightness and/or an operating temperature; and outputting a gate voltage to a first gate drive circuit in a plurality of groups of gate drive circuits based on the status information. The first gate drive circuit is configured to output a gate scanning signal to a corresponding pixel circuit based on the gate voltage. The gate voltage is a first voltage when the status information is a first value, the gate voltage is a second voltage when the status information is a second value, and an amplitude of the second voltage is less than an amplitude of the first voltage.

### CROSS-REFERENCE TO RELATED APPLICATIONS

This is a continuation of International Patent Application No. PCT/CN2024/144125, filed on Dec. 31, 2024, which claims priority to Chinese Patent Application No. 202410281526.5, filed on Mar. 8, 2024 which are both incorporated by reference.

### TECHNICAL FIELD

Embodiments of this disclosure relate to the field of display technologies, and in particular, to a method for driving a display apparatus, a display apparatus, and a display device.

### BACKGROUND

With rapid development of science and technology, semiconductor devices are widely used in display devices (such as a mobile phone, a tablet computer, and a television). The display device may include a plurality of light-emitting devices and a plurality of drive circuits configured to drive the light-emitting devices. The light-emitting device may be a light-emitting diode (LED). An organic LED (OLED) is made of a new semiconductor material with a self-luminous characteristic, can emit light under an action of the drive circuit, and has advantages such as high contrast, high brightness, wide color gamut, and fast response time.

As users have increasingly higher requirements on image quality and contrast, brightness of the display device is continuously increased, and power consumption of the display device is also continuously increased. Therefore, a technical solution that can reduce power consumption of the display device is urgently needed.

### SUMMARY

Embodiments of this disclosure provide a method for driving a display apparatus, a display apparatus, and a display device, to reduce power consumption of the display apparatus.

To achieve the foregoing objective, the following technical solutions are used in embodiments of this disclosure.

According to a first aspect, an embodiment of this disclosure provides a method for driving a display apparatus. The display apparatus includes a plurality of groups of gate drive circuits and a plurality of pixel circuits. The method includes: obtaining status information of the display apparatus, where the status information includes display brightness and/or an operating temperature; and outputting a gate voltage to a first gate drive circuit in a plurality of groups of gate drive circuits based on the status information. The first gate drive circuit is configured to output a gate scanning signal to a corresponding pixel circuit based on the gate voltage. The gate voltage is a first voltage when the status information is a first value, the gate voltage is a second voltage when the status information is a second value, and an amplitude of the second voltage is less than an amplitude of the first voltage.

Therefore, in the method for driving a display apparatus provided in embodiments of this disclosure, the display apparatus may output gate voltages with different voltage amplitudes to a first gate drive circuit based on different status information (display brightness and/or operating temperatures) of the display apparatus. For example, a first voltage is output when the status information is a first value, and a second voltage is output when the status information is a second value. An amplitude of the second voltage is less than an amplitude of the first voltage. In this way, power consumption of the display apparatus can be reduced by decreasing an amplitude of a gate voltage.

In a possible design, outputting the gate voltage to the first gate drive circuit in the plurality of groups of gate drive circuits based on the status information includes: outputting the gate voltage to the first gate drive circuit in the plurality of groups of gate drive circuits based on the status information and a preset correspondence, where the preset correspondence is a correspondence between the status information and the gate voltage. Therefore, an amplitude of the gate voltage may be determined based on the status information and the preset correspondence, to output the gate voltage with the corresponding amplitude to the first gate drive circuit. Compared with a fixed amplitude of the gate voltage, a dynamic amplitude of the gate voltage can reduce power consumption of the display apparatus.

In a possible design, the status information includes the display brightness of the display apparatus, and display brightness corresponding to the first value is higher than display brightness corresponding to the second value. Therefore, when the display brightness of the display apparatus decreases, the amplitude of the gate voltage may be decreased, to reduce power consumption of the display apparatus.

In a possible design, the status information includes the operating temperature of the display apparatus, and an operating temperature corresponding to the first value is lower than an operating temperature corresponding to the second value. Therefore, when the operating temperature of the display apparatus increases, the amplitude of the gate voltage may be decreased, to reduce power consumption of the display apparatus.

In a possible design, the status information includes the display brightness and the operating temperature of the display apparatus, and the amplitude of the gate voltage is related to the display brightness and the operating temperature. Therefore, the amplitude of the gate voltage may be related to both the display brightness and the operating temperature. Different amplitudes of the gate voltage may be determined based on different states of the display apparatus. Compared with the fixed amplitude of the gate voltage, the dynamic amplitude of the gate voltage can reduce power consumption of the display apparatus.

In a possible design, the gate scanning signal is used to initialize an anode of an LED in the pixel circuit. The gate scanning signal may be used to turn on a transistor in the pixel circuit to initialize the anode of the LED in the pixel circuit. An amplitude of the gate scanning signal is related to the amplitude of the gate voltage. Therefore, the amplitude of the gate scanning signal may be decreased by decreasing the amplitude of the gate voltage, thereby further reducing power consumption of the display apparatus.

In a possible design, the gate scanning signal is used to control the pixel circuit to write a data signal. The gate scanning signal may be used to turn on a transistor in the pixel circuit to control the pixel circuit to write the data signal. An amplitude of the gate scanning signal is related to the amplitude of the gate voltage. Therefore, the amplitude of the gate scanning signal may be decreased by decreasing the amplitude of the gate voltage, thereby further reducing power consumption of the display apparatus.

In a possible design, the method further includes: outputting a gate voltage to a second gate drive circuit in the plurality of groups of gate drive circuits based on the status information. The gate voltage is a third voltage when the status information is the first value, the gate voltage is a fourth voltage when the status information is the second value, an amplitude of the fourth voltage is less than an amplitude of the third voltage, and levels of the third voltage and the fourth voltage are opposite to levels of the first voltage and the second voltage. Therefore, according to the method for driving a display apparatus provided in embodiments of this disclosure, the gate voltages output by the first gate drive circuit and the second gate drive circuit may be adjusted at the same time, to further reduce power consumption of the display apparatus.

In a possible design, outputting the gate voltage to the first gate drive circuit in the plurality of groups of gate drive circuits based on the status information includes: outputting the gate voltage to the first gate drive circuit in the plurality of groups of gate drive circuits after waiting for at least one refresh cycle, and outputting the gate voltage to the second gate drive circuit in the plurality of groups of gate drive circuits after waiting for at least one refresh cycle. Therefore, when a status of the display apparatus changes, the display apparatus may adjust the amplitude of the gate voltage after waiting for at least one refresh cycle, and more time may be reserved for voltage switching. This helps reduce flickering.

According to a second aspect, an embodiment of this disclosure provides a display apparatus. The display apparatus includes a peripheral drive circuit, a plurality of groups of gate drive circuits, and a plurality of pixel circuits. The peripheral drive circuit is configured to obtain status information of the display apparatus, where the status information includes display brightness and/or an operating temperature. The peripheral drive circuit is further configured to output a gate voltage to a first gate drive circuit in the plurality of groups of gate drive circuits based on the status information, and the first gate drive circuit is configured to output a gate scanning signal to a corresponding pixel circuit based on the gate voltage. The gate voltage is a first voltage when the status information is a first value, the gate voltage is a second voltage when the status information is a second value, and an amplitude of the second voltage is less than an amplitude of the first voltage.

In a possible design, the peripheral drive circuit is configured to output the gate voltage to the first gate drive circuit in the plurality of groups of gate drive circuits based on the status information and a preset correspondence, and the preset correspondence is a correspondence between the status information and the gate voltage.

In a possible design, the status information includes the display brightness of the display apparatus, and display brightness corresponding to the first value is higher than display brightness corresponding to the second value.

In a possible design, the status information includes the operating temperature of the display apparatus, and an operating temperature corresponding to the first value is lower than an operating temperature corresponding to the second value.

In a possible design, the status information includes the display brightness and the operating temperature of the display apparatus, and the amplitude of the gate voltage is related to the display brightness and the operating temperature.

In a possible design, the gate scanning signal is used to initialize an anode of an LED in the pixel circuit.

In a possible design, the gate scanning signal is used to control the pixel circuit to write data.

In a possible design, the peripheral circuit is further configured to output a gate voltage to a second gate drive circuit in the plurality of groups of gate drive circuits based on the status information. The gate voltage is a third voltage when the status information is the first value, the gate voltage is a fourth voltage when the status information is the second value, an amplitude of the fourth voltage is less than an amplitude of the third voltage, and levels of the third voltage and the fourth voltage are opposite to levels of the first voltage and the second voltage.

In a possible design, the peripheral drive circuit is configured to: output the gate voltage to the first gate drive circuit in the plurality of groups of gate drive circuits after waiting for at least one refresh cycle, and output the gate voltage to the second gate drive circuit in the plurality of groups of gate drive circuits after waiting for at least one refresh cycle.

In a possible design, the peripheral drive circuit is coupled to the plurality of groups of gate drive circuits through a plurality of voltage signal lines, and the peripheral drive circuit is coupled to the first gate drive circuit in the plurality of groups of gate drive circuits through a first voltage signal line in the plurality of voltage signal lines. The peripheral drive circuit is coupled to the second gate drive circuit in the plurality of groups of gate drive circuits through a second voltage signal line in the plurality of voltage signal lines. In this way, if the first voltage signal line is coupled to only the first gate drive circuit, and the second voltage signal line is coupled to only the second gate drive circuit, loads of the first voltage signal line and the second voltage signal line can be reduced, and a display effect can be improved. If the first voltage signal line is further coupled to another gate drive circuit, and the second voltage signal line is further coupled to another gate drive circuit, power consumption of the display apparatus can be further reduced.

In a possible design, the first voltage signal line or the second voltage signal line includes at least two metal layers, and the at least two metal layers are connected to each other through at least one connection hole. Therefore, if the first voltage signal line or the second voltage signal line is formed by overlapping a plurality of metal layers, resistance of the first voltage signal line or the second voltage signal line can be reduced, thereby further reducing a load of the voltage signal line and improving a display effect.

For some beneficial effects of the second aspect, refer to beneficial effects of the first aspect.

According to a third aspect, an embodiment of this disclosure provides a display device. The display device includes a processor and a display apparatus. The processor is configured to output status information to the display apparatus, where the status information includes display brightness and/or an operating temperature. The peripheral drive circuit is configured to obtain the status information of the display apparatus. The peripheral drive circuit is further configured to output a gate voltage to a first gate drive circuit in the plurality of groups of gate drive circuits based on the status information, and the first gate drive circuit is configured to output a gate scanning signal to a corresponding pixel circuit based on the gate voltage. The gate voltage is a first voltage when the status information is a first value, the gate voltage is a second voltage when the status information is a second value, and an amplitude of the second voltage is less than an amplitude of the first voltage.

According to a fourth aspect, an embodiment of this disclosure provides a computer-readable storage medium, including computer instructions. When the computer instructions are run on an electronic device, the electronic device is enabled to perform the method for driving a display apparatus according to any one of the foregoing aspects and the possible implementations.

According to a fifth aspect, an embodiment of this disclosure provides a computer program product. When the computer program product runs on a computer or a processor, the computer or the processor is enabled to perform the method for driving a display apparatus according to any one of the foregoing aspects and the possible implementations.

It may be understood that any display apparatus, display device, computer-readable storage medium, computer program product, or the like provided above may be used in the corresponding method provided above. Therefore, for beneficial effects that can be achieved by the display apparatus, the display device, the computer-readable storage medium, the computer program product, or the like, refer to the beneficial effects in the corresponding method. Details are not described herein again.

These aspects or other aspects in this disclosure are more concise and comprehensible in the following descriptions.

### BRIEF DESCRIPTION OF DRAWINGS

FIG. 1 is a diagram of a structure of a display apparatus according to an embodiment of this disclosure.

FIG. 2A and FIG. 2B are diagrams of a relationship between display brightness and a current of an OLED and a relationship between a device voltage and a current of an OLED according to an embodiment of this disclosure.

FIG. 3 is a diagram of a relationship between a current and a device voltage of an OLED according to an embodiment of this disclosure.

FIG. 4 is a diagram of a structure of a gate drive circuit according to an embodiment of this disclosure.

FIG. 5 is a time sequence diagram of a gate scanning signal of a gate drive circuit according to an embodiment of this disclosure.

FIG. 6 is a diagram of a structure of a peripheral drive circuit according to an embodiment of this disclosure.

FIG. 7 is a diagram of a structure of a pixel circuit according to an embodiment of this disclosure.

FIG. 8 is a time sequence diagram of a pixel circuit according to an embodiment of this disclosure.

FIG. 9 is a time sequence diagram of a pixel circuit in different states according to an embodiment of this disclosure.

FIG. 10 is a flowchart of a method for driving a display apparatus according to an embodiment of this disclosure.

FIG. 11 is a diagram of a structure of another pixel circuit according to an embodiment of this disclosure.

FIG. 12 is a time sequence diagram at different display brightness levels according to an embodiment of this disclosure.

FIG. 13 is a time sequence diagram at different operating temperatures according to an embodiment of this disclosure.

FIG. 14 is a diagram of a structure of yet another pixel circuit according to an embodiment of this disclosure.

FIG. 15 is another time sequence diagram at different display brightness levels according to an embodiment of this disclosure.

FIG. 16 is another time sequence diagram at different operating temperatures according to an embodiment of this disclosure.

FIG. 17 is a diagram of a structure of yet another pixel circuit according to an embodiment of this disclosure.

FIG. 18 is a time sequence diagram of yet another pixel circuit according to an embodiment of this disclosure.

FIG. 19A and FIG. 19B are time sequence diagrams of yet another pixel circuit according to an embodiment of this disclosure.

FIG. 20 is a diagram of a structure of yet another peripheral drive circuit according to an embodiment of this disclosure.

FIG. 21 is a time sequence diagram of a peripheral drive circuit according to an embodiment of this disclosure.

FIG. 22 is a diagram of a structure of yet another display apparatus according to an embodiment of this disclosure.

FIG. 23 is a diagram of a structure of yet another display apparatus according to an embodiment of this disclosure.

FIG. 24 is a cross-sectional view of a voltage signal line according to an embodiment of this disclosure.

### DETAILED DESCRIPTION

For ease of understanding, some concepts related to embodiments of this disclosure are described for reference by using examples. Details are as follows:

1. Initial voltage (VINI): In embodiments of this disclosure, the initial voltage may be used for anode reset of an LED and gate reset of a drive transistor.

2. Buck-boost converter: The buck-boost converter is a commonly used direct current-direct current (DC/DC) conversion circuit, where an output voltage of the circuit may be lower than or higher than an input voltage of the circuit, and polarities of the output voltage and the input voltage of the circuit are opposite.

The following describes the technical solutions in embodiments of this disclosure with reference to the accompanying drawings in embodiments of this disclosure. In description in embodiments of this disclosure, “/” means “or” unless otherwise specified. For example, A/B may represent A or B. In this specification, “and/or” describes only an association relationship for describing associated objects and represents that three relationships may exist. For example, A and/or B may represent the following three cases: Only A exists, both A and B exist, and only B exists. In addition, in the descriptions in embodiments of this disclosure, “a plurality of” means two or more.

The terms “first” and “second” mentioned below are merely intended for a purpose of description, and shall not be understood as an indication or implication of relative importance or implicit indication of the number of indicated technical features. Therefore, a feature limited by “first” or “second” may explicitly or implicitly include one or more features. In the descriptions of embodiments, unless otherwise specified, “a plurality of” means two or more.

The technical solutions provided in embodiments of this disclosure may be applied to various electronic devices including a display apparatus. The electronic device is, for example, a consumer electronic product, a home electronic product, a vehicle-mounted electronic product, or a financial electronic device product that has a display function. The consumer electronic product is, for example, a mobile phone, a tablet computer, a notebook computer, an e-reader, a personal computer (PC), a personal digital assistant (PDA), a desktop display, an intelligent wearable product (for example, a smartwatch or a smart band), a virtual reality (VR) electronic device, an augmented reality (AR) electronic device, or an uncrewed aerial vehicle. The home electronic product is, for example, a smart door lock, a television, a remote control, a refrigerator, a small household charging appliance (for example, a soy milk maker or a robot vacuum), or the like. The vehicle-mounted electronic product is, for example, a vehicle-mounted navigator or a vehicle-mounted high-density digital video disc (DVD). The financial electronic device product is, for example, an automated teller machine (ATM) or an electronic device for self-help services. A specific form of the electronic device is not limited in embodiments of this disclosure.

For ease of understanding, the following first describes a specific structure of the display apparatus.

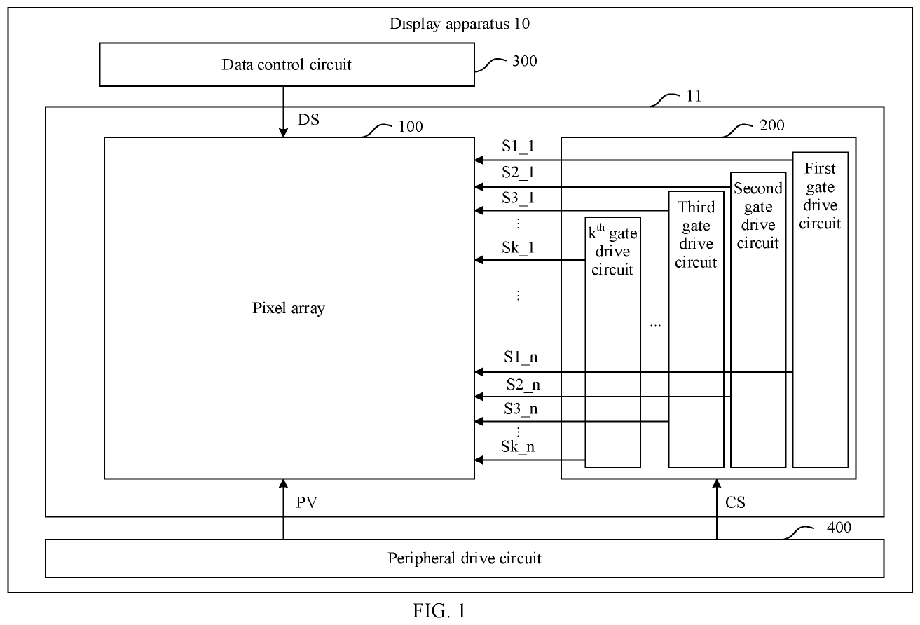

As shown in FIG. 1, FIG. 1 is a diagram of a structure of a display apparatus according to an embodiment of this disclosure. A display apparatus 10 may include an active display area (AA) 100, a non-active display area (NA) 200, a data control circuit 300, and a peripheral drive circuit 400. The active display area 100 and the non-active display area 200 form a display panel 11. The active display area 100 is a pixel light emission area, and the non-active display area 200 is a non-light emission area on the display panel 11. The data control circuit 300 is configured to provide data signals (DS) to the display panel 11 after receiving external image information, where the data signal is a digital signal that determines a pixel light emission current in pixel circuit programming. The peripheral drive circuit 400 is configured to provide a plurality of groups of control signals (CS) and a plurality of pixel voltages (PV) that may be required by the display panel.

The active display area 100 may include a plurality of pixels arranged in an array form (for example, a pixel array), a plurality of data lines, and a plurality of gate scanning lines. Each data line is coupled to the plurality of pixels in a Y direction, each gate scanning line is coupled to the plurality of pixels in an X direction, and each pixel is coupled to a data line, a gate scanning line, a power supply voltage (positive power supply voltage (ELVDD) and negative power supply voltage (ELVSS)) line, and a VINI line. The pixel may be understood as a pixel circuit. The pixel circuit may include an LED and a circuit unit configured to control the LED. The LED may be an OLED, a quantum dot LED (QLED), a mini-LED, or a micro-LED. When executing a specific pixel circuit time sequence, the circuit unit may control a current value from an ELVDD to an ELVSS, and the LED may emit light with specific brightness under a specific current value.

The non-active display area 200 is located on one or two sides of the active display area 100, and may include a plurality of gate drive circuits. Because the non-active display area 200 uses a gate driver on array (GOA) technology, the gate drive circuit is also referred to as a GOA circuit. After receiving a control signal, the GOA circuit may generate a plurality of shift pulse signals that are output row by row, for example, a plurality of gate scanning signals. Each gate signal line (GL) is coupled to one or more rows of pixel circuits. The gate scanning signals are output row by row, to control thin film transistors (TFTs) in the pixel circuits to be turned on or off row by row. Still refer to FIG. 1. The non-active display area 200 may include k gate drive circuits, which are a first gate drive circuit, a second gate drive circuit, a third gate drive circuit, . . . , and a kth gate drive circuit. Each gate drive circuit outputs gate scanning signals for controlling a plurality of rows of pixel circuits. For example, gate scanning signals for controlling a first row of pixel circuits are S1_1, S2_1, S3_1, . . . , and Sk_1, and gate scanning signals for controlling an n^{th} row of pixel circuits are S1_n, S2_n, S3_n, . . . , and Sk_n.

The data control circuit 300 is configured to provide a plurality of groups of data signals. The data control circuit 300 transmits the data signals to pixel circuits in the display panel 11 through a plurality of data lines, so that the pixel circuits can operate normally. A quantity of the plurality of data lines may be the same as a total quantity of columns of a pixel array including the pixel circuits.

The peripheral drive circuit 400 is configured to provide a plurality of groups of control signals. The control signals may include a start vertical signal (STV), a clock signal (CLK), a gate high-level voltage (VGH), and a gate low-level voltage (VGL). After receiving the control signals, the gate drive circuit generates corresponding high-level and low-level gate scanning signals. In addition, the peripheral drive circuit 400 is further configured to provide a plurality of groups of pixel voltages. The pixel voltages may include a power supply voltage (VDD and VSS) and an initial voltage. The peripheral drive circuit 400 transmits the pixel voltages to the pixel circuits in the display panel 11 through the plurality of signal lines, so that the pixel circuits can operate normally.

On the basis of the display apparatus shown in FIG. 1, the following further describes the pixel circuit, the gate drive circuit, and the peripheral drive circuit.

Each pixel circuit includes an OLED. Display brightness of the display apparatus is determined by a current of the OLED. A larger current of the OLED indicates higher display brightness of the display apparatus, and a smaller current of the OLED indicates lower display brightness of the display apparatus. The current of the OLED satisfies the following relationship: I_{OLED}=K(ELVDD−V_{data})², where K is a process-related constant, ELVDD is a positive power supply voltage, and V_{data} is a turn-on voltage of the OLED. Because V_{data} is a positive number, and it can be seen from the foregoing formula that the current of the OLED is inversely proportional to V_{data}, smaller V_{data} indicates higher display brightness of the display apparatus.

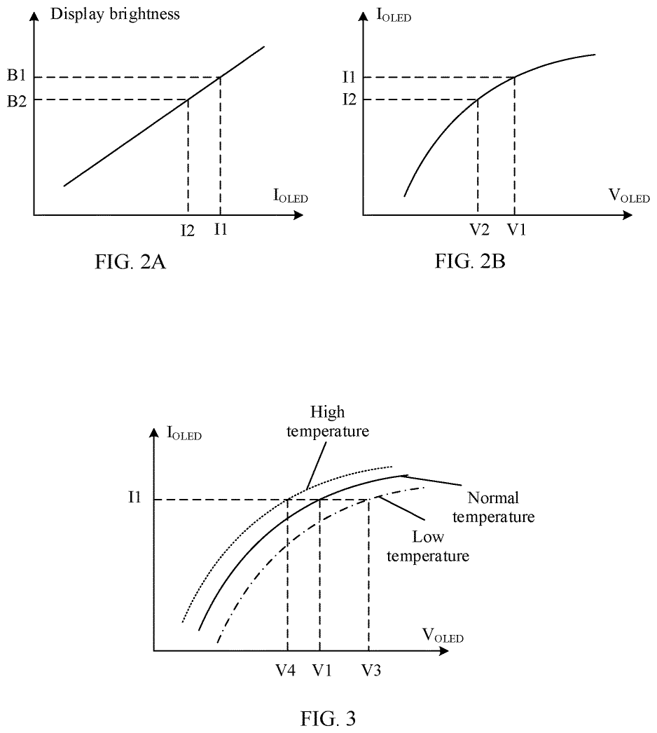

As shown in FIG. 2A and FIG. 2B, FIG. 2A and FIG. 2B are diagrams of a relationship between display brightness and a current of an OLED and a relationship between a device voltage and a current of an OLED according to an embodiment of this disclosure. A device voltage of the OLED is a cross voltage V_{OLED} from an anode to a cathode of the OLED. FIG. 2A shows a relationship between the display brightness and I_{OLED}, and FIG. 2B shows a relationship between I_{OLED} and V_{OLED}. There is a positive correlation between the display brightness of the OLED and I_{OLED}. Higher I_{OLED} indicates higher display brightness of the OLED. In addition, there is also a positive correlation between I_{OLED} and V_{OLED}. Higher I_{OLED} indicates larger V_{OLED}. Therefore, lower display brightness of the display apparatus indicates lower V_{OLED}. In an example, when the brightness of the display apparatus decreases from B1 to B2, I_{OLED} decreases from I1 to I2, and V_{OLED} also needs to decrease from V1 to V2.

In addition, V_{OLED} is further related to an operating temperature of the display apparatus. As shown in FIG. 3, FIG. 3 is a diagram of a relationship between a current and the device voltage of the OLED according to an embodiment of this disclosure. FIG. 3 separately shows relationships between I_{OLED} and V_{OLED} in a high-temperature scenario, a normal-temperature scenario, and a low-temperature scenario. At a normal temperature, when V_{OLED} is V1, I_{OLED} is I1. When the operating temperature of the display apparatus changes from a low temperature to a high temperature, V_{OLED} is also lower. In an example, when the operating temperature of the display apparatus changes from a low temperature to a high temperature, V_{OLED} needs to decrease from V3 to V4.

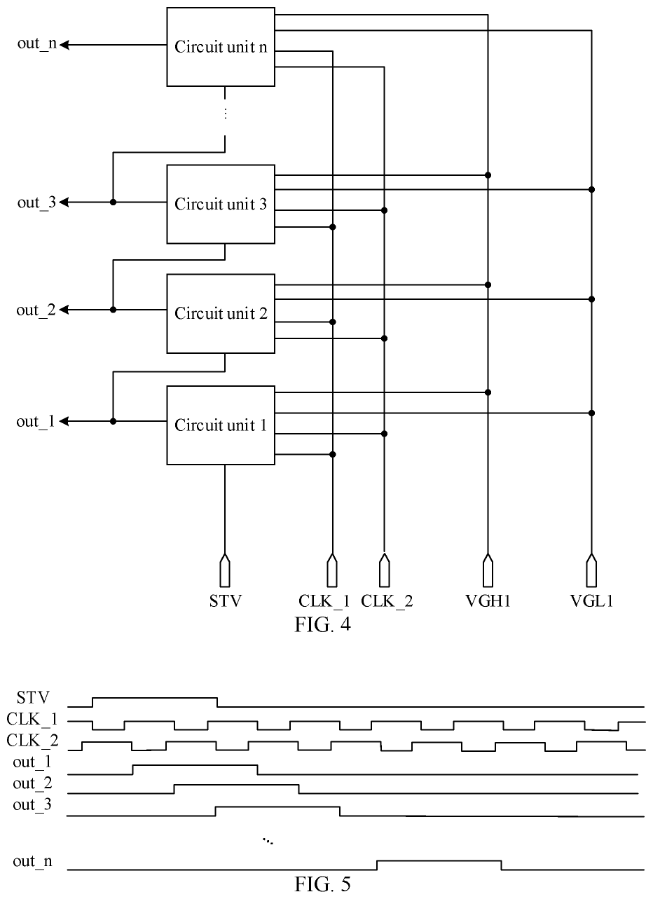

The gate drive circuit may include a plurality of levels of circuit units. As shown in FIG. 4, FIG. 4 is a diagram of a structure of the gate drive circuit according to an embodiment of this disclosure. FIG. 4 shows n levels of circuit units, which are respectively a circuit unit 1, a circuit unit 2, a circuit unit 3, . . . , and a circuit unit n. The circuit unit 1 outputs a gate scanning signal out_1, the circuit unit 2 outputs a gate scanning signal out_2, the circuit unit 3 outputs a gate scanning signal out_3, and the circuit unit n outputs a gate scanning signal out_n, where out_1 to out_n respectively correspond to a first row of pixel circuits to an n^{th} row of pixel circuits. In other words, one row of gate scanning signals may control one row of pixel circuits. In addition, one row of gate scanning signals may alternatively control two rows of pixel circuits. For example, the gate scanning signal out_1 may correspond to the first row of pixel circuits and the second row of pixel circuits, the gate scanning signal out_2 may correspond to the third row of pixel circuits and the fourth row of pixel circuits, and by analogy, the gate scanning signal out_n may correspond to the (2n−1)^{th} row of pixel circuits and the 2n^{th} row of pixel circuits.

Still refer to FIG. 4. After receiving a start vertical signal (STV), a first clock signal (CLK_1), a second clock signal (CLK_2), a gate signal high-level voltage (VGH1), and a gate signal low-level voltage (VGL1) that are generated by a peripheral drive circuit, the circuit unit 1 responds by generating the gate scanning signals out_1 to out_n that are output row by row. The circuit unit 1 is coupled to a start frame signal line, other circuit units are respectively coupled to output ends of previous-stage circuit units, and a gate scanning signal output by the previous-stage circuit unit is used as a start signal of a next-stage circuit unit. For example, an input end of the circuit unit 2 is coupled to an output end of the circuit unit 1, and the gate scanning signal out_1 output by the circuit unit 1 is used as an input signal of the circuit unit 2. Alternatively, an input end of the circuit unit 3 is coupled to an output end of the circuit unit 2, and the gate scanning signal out_2 output by the circuit unit 2 is used as an input signal of the circuit unit 3.

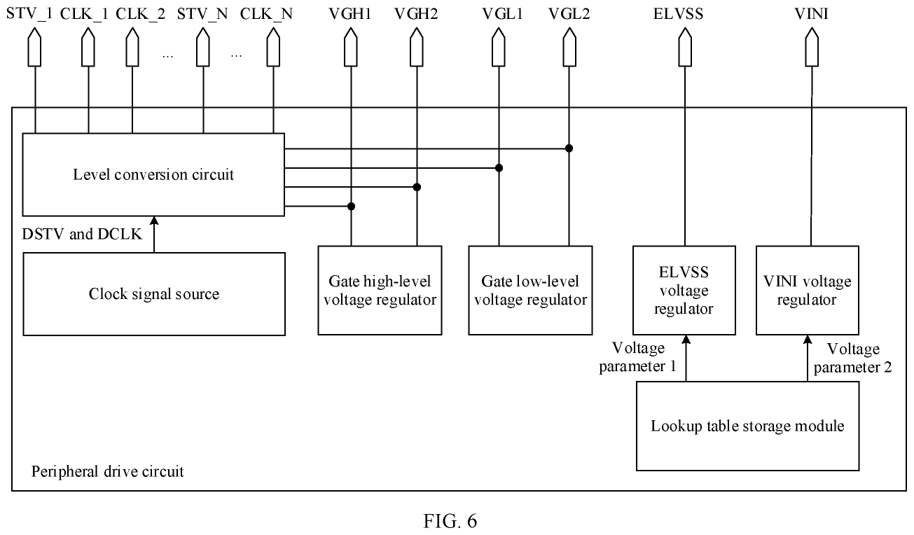

As shown in FIG. 5, FIG. 5 is a time sequence diagram of the gate scanning signal of the gate drive circuit in FIG. 4. FIG. 5 shows a time sequence diagram of the start vertical signal (STV), the first clock signal (CLK_1), the second clock signal (CLK_2), and the gate scanning signal out_1 to the gate scanning signal out_n. The gate scanning signal is a square wave signal that switches between a high-level voltage and a low-level voltage, a high-level voltage value of the gate scanning signal is equal to a voltage value of the gate signal high-level voltage (VGH1), and a low-level voltage value of the gate scanning signal is equal to a voltage value of the gate signal low-level voltage (VGL1).

A diagram of a structure of the peripheral drive circuit is shown in FIG. 6. The peripheral drive circuit may generate a control signal and a pixel voltage signal. The peripheral drive circuit may include a lookup table (LUT) storage module and a plurality of voltage regulators. The plurality of voltage regulators may be an ELVSS voltage regulator, a VINI voltage regulator, a gate high-level voltage regulator, a gate low-level voltage regulator, and the like. The peripheral drive circuit is configured to: receive status data (for example, brightness data and temperature data), invoke voltage parameters, for example, a voltage parameter 1 and a voltage parameter 2, in the lookup table storage module, and send the voltage parameters to corresponding voltage regulators. The ELVSS voltage regulator may generate ELVSS based on the voltage parameter 1, and the VINI voltage regulator may generate VINI based on the voltage parameter 2. In addition, the gate high-level voltage regulator may generate VGH1 and VGH2, and the gate low-level voltage regulator may generate VGL1 and VGL2. It may be understood that the gate high-level voltage regulator and the gate low-level voltage regulator may alternatively be integrated into a same module. This is not limited in embodiments of this disclosure.

For example, the lookup table storage module may be a random-access memory (RAM), and the voltage regulator may be a low-dropout regulator (LDO), a buck-boost converter, or a charge pump.

In addition, still refer to FIG. 6. The peripheral drive circuit may further include a clock signal source, and the clock signal source may generate a data start vertical signal (DSTV) and a data clock signal (DCLK). The peripheral drive circuit may further include a level conversion circuit. The level conversion circuit may convert DSTV into STV_1 to STV_N and convert DCLK into CLK_1, CLK_2, . . . , and CLK_N based on voltage values of VGH1, VGH2, VGL1, and VGL2. High-level voltage values of the converted start frame signal and clock signal may be VGH1 or VGH2, and low-level voltage values may be VGL1 or VGL2. When a voltage value of VGH1, VGH2, VGL1, or VGL2 changes, voltage values of STV_1 to STV_N and CLK_1 to CLK_N also dynamically change. Further, the peripheral drive circuit further outputs the control signal to the gate drive circuit, so that the gate drive circuit can output gate control signals with different high and low-level voltage values.

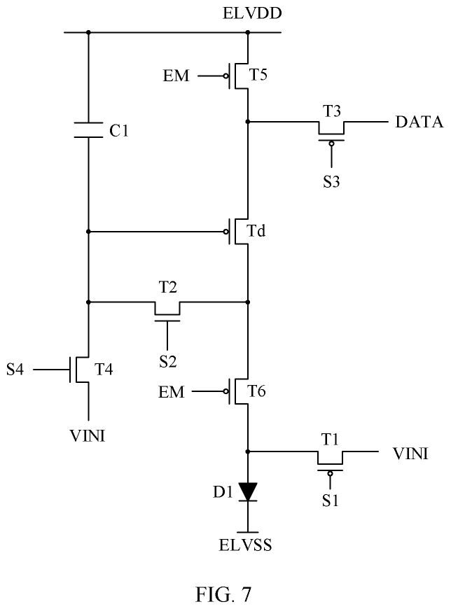

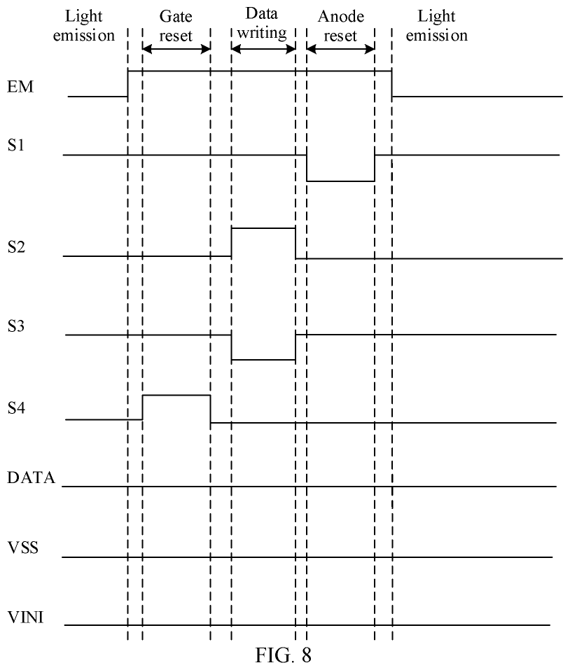

As shown in FIG. 7 and FIG. 8, FIG. 7 is a diagram of a structure of the pixel circuit according to an embodiment of this disclosure, and FIG. 8 is a time sequence diagram of the pixel circuit according to an embodiment of this disclosure. The pixel circuit is a circuit with seven transistors and one capacitor, a 7T1C circuit. The pixel circuit includes a capacitor (represented by C1 in FIG. 7), a light-emitting diode (represented by D1 in FIG. 7), a plurality of P-type transistors (respectively represented by T1, T3, T5, T6, and Td in FIG. 7), and a plurality of N-type transistors (respectively represented by T2 and T4 in FIG. 7). A gate scanning signal of T1 is S1, a gate scanning signal of T2 is S2, a gate scanning signal of T3 is S3, a gate scanning signal of T4 is S4, and gate scanning signals of T5 and T6 are light emission signals (EM). One end of T1 and one end of T4 are configured to input a VINI, and one end of T3 is configured to input a data signal (DATA). It may be understood that the structure of the pixel circuit may alternatively be in another form, for example, six transistors and one capacitor (6T1C) or eight transistors and one capacitor (8T1C). The specific structure of the pixel circuit is not limited in embodiments of this disclosure.

Refer to FIG. 8. A light emission process of the pixel circuit may include: (1) A voltage value of the EM signal is increased. In this case, T5 and T6 are turned off, and D1 stops emitting light. (2) A voltage of the S4 signal is increased. In this case, T4 is turned on, and the VINI is written into Td to reset a gate of Td, which is gate reset. (3) A voltage of the S3 signal is decreased. In this case, T3 is turned on. At the same time, a voltage of the S2 signal is increased. In this case, T2 is turned on. The data signal (DATA) is written into the gate of Td through T3, Td, and T2, which is data writing. (4) A voltage of the S1 signal is decreased. In this case, T1 is turned on, and the initial voltage is written into an anode of D1, which is anode reset. (5) A voltage of the EM signal is decreased. In this case, T5 and T6 are turned on, and D1 starts to emit light.

In some possible implementations, a processor sends instructions to the peripheral drive circuit based on different states (for example, different brightness or temperatures) of the pixel circuit. It is assumed that when the display brightness of the pixel circuit changes from high brightness to low brightness, as shown in FIG. 9, a data voltage (DATA), an ELVSS voltage, and a VINI voltage output by the peripheral drive circuit increase. To be specific, the data voltage increases from a first data voltage to a second data voltage, the ELVSS voltage increases from a first negative power supply voltage to a second negative power supply voltage, and the VINI voltage increases from a first initial voltage to a second initial voltage. In this case, voltages of the gate scanning signals output by the gate drive circuit, for example, the signals S1, S2, S3, and S4, do not change, and power consumption of a display apparatus is still high.

Therefore, to further reduce power consumption, an embodiment of this disclosure provides a method for driving a display apparatus. The display apparatus may output gate voltages with different voltage amplitudes to a first gate drive circuit based on different status information (display brightness and/or operating temperatures) of the display apparatus. For example, a first voltage is output when the status information is a first value, and a second voltage is output when the status information is a second value. An amplitude of the second voltage is less than an amplitude of the first voltage. In this way, power consumption of the display apparatus can be reduced by decreasing an amplitude of a gate voltage.

The following describes the method for driving a display apparatus provided in an embodiment of this disclosure, which is applied to the foregoing display apparatus.

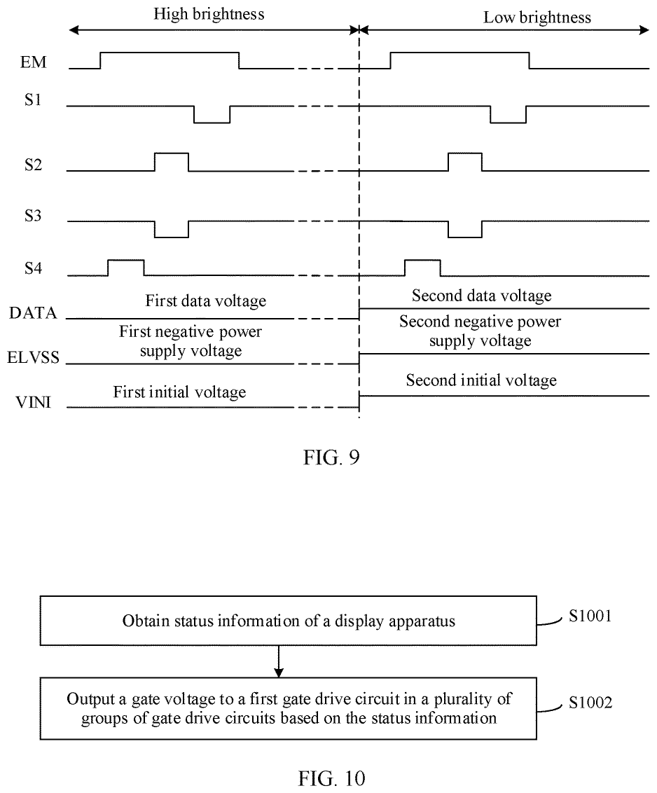

As shown in FIG. 10, FIG. 10 is a flowchart of a method for driving a display apparatus according to an embodiment of this disclosure. The method includes the following procedure.

S1001: Obtain status information of the display apparatus.

The status information includes display brightness and/or an operating temperature.

For example, the display brightness may be brightness data that needs to be displayed by a pixel circuit in a next refresh cycle, and the operating temperature may be a temperature of an environment in which the display apparatus is located.

Refer to FIG. 2A and FIG. 2B. It can be learned that when the display brightness of the display apparatus changes, a current flowing through an OLED also changes, and a device voltage of the OLED also changes. When the display brightness of the display apparatus decreases, the current flowing through the OLED decreases. In this case, the device voltage of the OLED also decreases.

Refer to FIG. 3. It can be learned that when the operating temperature of the display apparatus changes, the device voltage of the OLED also changes. When the operating temperature of the display apparatus increases, the device voltage of the OLED decreases.

S1002: Output a gate voltage to a first gate drive circuit in a plurality of groups of gate drive circuits based on the status information.

The first gate drive circuit is configured to output a gate scanning signal to a corresponding pixel circuit based on the gate voltage. The gate voltage is a first voltage when the status information is a first value, the gate voltage is a second voltage when the status information is a second value, and an amplitude of the second voltage is less than an amplitude of the first voltage.

For example, the gate voltage may be a VGH or a VGL, a high-level voltage value of the gate scanning signal is equal to a voltage value of VGH, and a low-level voltage value of the gate scanning signal is equal to a voltage value of VGL.

For example, the first value or the second value may include only the display brightness or the operating temperature, or the first value or the second value may include both the display brightness and the operating temperature.

For example, the first gate drive circuit may include one or more groups of gate drive circuits, and gate scanning signals output by each group of gate drive circuits may control one or more rows of pixel circuits.

For example, the display apparatus may output gate voltages with different voltage amplitudes to the first gate drive circuit based on different status information, so that gate scanning signals with different voltage amplitudes may be obtained. When a status of the display apparatus changes, an amplitude of the gate voltage may be decreased, to reduce power consumption of the display apparatus.

In some instances, S1002 may include: outputting the gate voltage to the first gate drive circuit in the plurality of groups of gate drive circuits based on the status information and a preset correspondence. The preset correspondence is a correspondence between the status information and the gate voltage.

For example, the preset correspondence may be stored in a lookup table storage module in the peripheral drive circuit. The lookup table may store a correspondence between the display brightness and the gate voltage, the lookup table may also store a correspondence between the operating temperature and the gate voltage, and the lookup table may also store a correspondence among the operating temperature, the display brightness, and the gate voltage. It may be understood that the lookup table may further store a correspondence between the status information and other voltage parameters. The other voltage parameters are, for example, a voltage value of ELVSS and a voltage value of VINI.

In some instances, the status information includes the display brightness and the operating temperature of the display apparatus, and the amplitude of the gate voltage is related to the display brightness and the operating temperature.

For example, when the status information includes the display brightness and the operating temperature, the preset correspondence is shown in Table 1. Table 1 shows voltage parameters corresponding to different operating temperatures and display brightness. Table 1 shows temperature data at operating temperatures from 1 °C to m °C (for example, T<1> to T<m>) and brightness data in display brightness from 1 nit to n nits (for example, B<1> to B<n>), where both m and n are positive integers. A voltage parameter corresponding to the operating temperature of 1 °C and the display brightness of 1 nit is a voltage setting <11>, and by analogy, a voltage parameter corresponding to the operating temperature of m °C and the display brightness of n nits is a voltage setting <mn>.

TABLE 1

| LUT | | | | | |
|---|---|---|---|---|---|
| Temperature | Brightness data | | | | |
| data | B<1> | B<2> | B<3> | . . . | B<n> |
| T<1> | Voltage setting | Voltage setting | Voltage setting | . . . | Voltage setting |
| | <11> | <12> | <13> | | <1n> |
| T<2> | Voltage setting | Voltage setting | Voltage setting | . . . | Voltage setting |
| | <21> | <22> | <23> | | <2n> |
| T<3> | Voltage setting | Voltage setting | Voltage setting | . . . | Voltage setting |
| | <31> | <32> | <33> | | <3n> |
| . . . | . . . | . . . | . . . | . . . | . . . |
| T<m> | Voltage setting | Voltage setting | Voltage setting | . . . | Voltage setting |
| | <m1> | <m2> | <m3> | | <mn> |

Table 2 shows a voltage parameter of the voltage setting <21> in Table 1. It may be understood that data in Table 2 is merely an example, and different pixel circuits have different voltage values.

TABLE 2
Voltage setting <21>, T<2> = 0 °C, B<1> = 2 nits

| | Voltage signal | | | | |
|---|---|---|---|---|---|
| | ELVSS | VINI | VGH1 | VGL1 | . . . |
| Voltage | ELVSS<21> = −3 V | VINI<21> = −2 V | VGH1<21> = 7 V | VGL1<21> = −7 V | . . . |
| value | | | | | |

It may be understood that Table 1 and Table 2 are merely examples of the lookup table, and different display apparatuses may have different data ranges. For example, the lookup table may not store temperature data, but store only one or more pieces of brightness data, or the lookup table may not store brightness data, but store only one or more pieces of temperature data. In addition, the lookup table may further include voltage data for pixels of different colors (for example, red, green, and blue), and the voltage parameter may further include data of other voltage signals like various voltage signals that may be required by the display apparatus, for example, VGH1, VGL1, VGH2, VGL2, VINI1, and VINI2.

In some instances, the gate scanning signal is used to initialize an anode of a light-emitting diode in the pixel circuit. The status information includes the display brightness of the display apparatus, and display brightness corresponding to the first value is higher than display brightness corresponding to the second value.

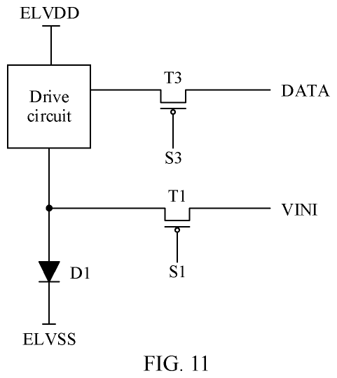

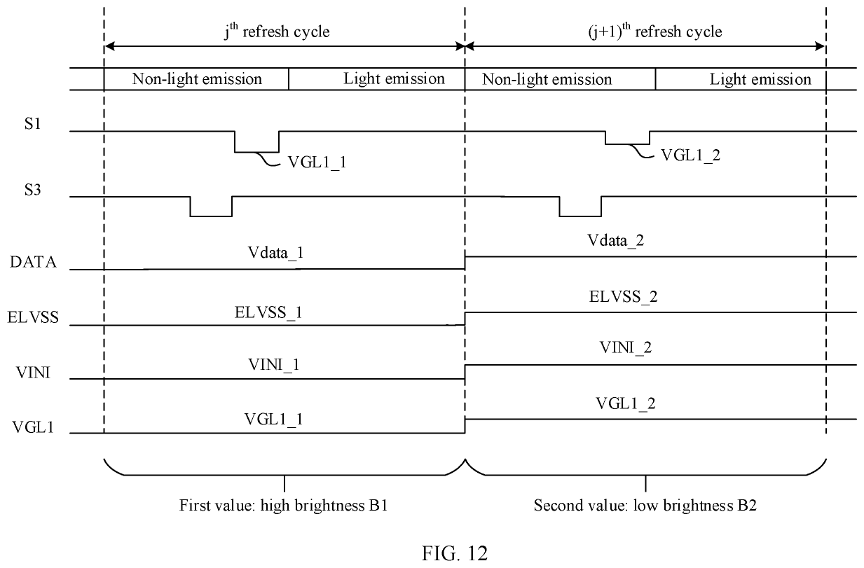

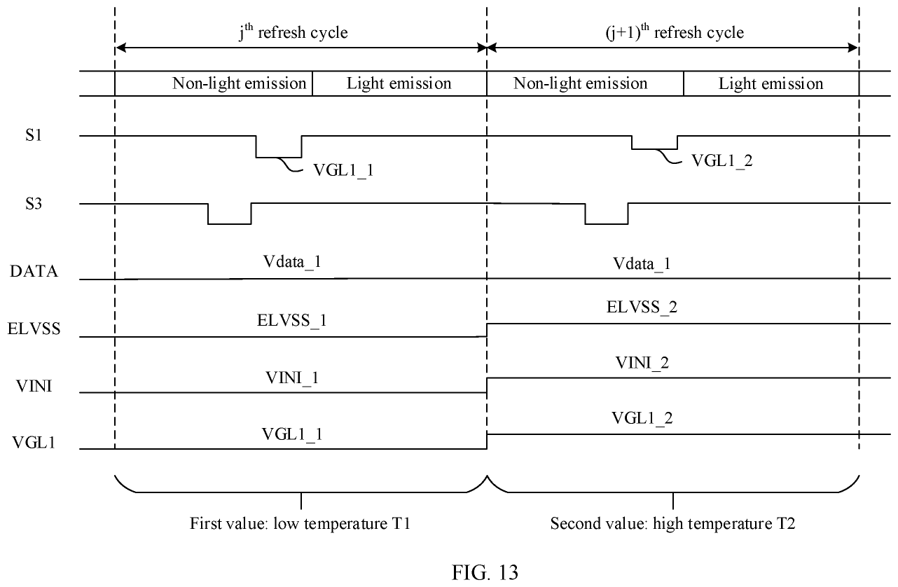

For example, an embodiment of this disclosure further provides a pixel circuit. As shown in FIG. 11, the pixel circuit may include a first transistor (represented by T1 in FIG. 11), a second transistor (represented by T3 in FIG. 11), a drive circuit, and a light-emitting diode (represented by D1 in FIG. 11). A gate scanning signal of T1 is S1, and a gate scanning signal of T3 is S3. In addition, a specific structure of the drive circuit is not limited in embodiments of this disclosure.

For example, the first transistor and the second transistor may be low-temperature polycrystalline silicon thin film transistors (LTPS TFTs), which are referred to as LTPS transistors for short. The first transistor and the second transistor may alternatively be indium gallium zinc oxide (IGZO) transistors. The first transistor and the second transistor may be alternatively transistors of another type. This is not limited in embodiments of this disclosure.

In different states of the display apparatus, amplitudes of a gate voltage of the S1 signal are different. For application in the pixel circuit shown in FIG. 11, FIG. 12 shows a time sequence diagram of the S1 signal at different display brightness levels of the display apparatus. FIG. 12 further shows a time sequence diagram of the S3 signal, a data signal DATA, a negative power supply voltage ELVSS, an initial voltage VINI, and a gate low-level voltage VGL1 at the different display brightness levels. FIG. 12 shows a time sequence diagram of various signals in a j^{th} refresh cycle and a (j+1)^{th} refresh cycle, where each refresh cycle includes a non-light emission phase and a light emission phase. In an example, it is assumed that the display apparatus receives an instruction, status information in the j^{th} refresh cycle is the first value, and status information in the (j+1)^{th} refresh cycle is the second value. In this case, an amplitude of VGL1 decreases from VGL1_1 to VGL1_2. Display brightness corresponding to the j^{th} refresh cycle is high brightness B1, the S1 signal is output by the first gate drive circuit, and a low-level voltage of an S1 signal waveform is equal to a gate low-level voltage VGL1_1 received by the first gate drive circuit. Display brightness corresponding to the (j+1)^{th} refresh cycle is low brightness B2, the low-level voltage of the S1 signal waveform is equal to a gate low-level voltage VGL1_2 received by the first gate drive circuit, and an amplitude of VGL1_2 is lower than an amplitude of VGL1_1.

In addition, an amplitude of a data voltage also decreases from Vdata_1 to Vdata_2, an amplitude of the negative power supply voltage also decreases from ELVSS_1 to ELVSS_2, and an amplitude of the initial voltage also decreases from VINI_1 to VINI_2, to further reduce power consumption of the display apparatus.

In some instances, the gate scanning signal is used to initialize an anode of a light-emitting diode in the pixel circuit. The status information includes the operating temperature of the display apparatus, and an operating temperature corresponding to the first value is lower than an operating temperature corresponding to the second value.

For example, for application in the pixel circuit in FIG. 11, FIG. 13 shows a time sequence diagram of the S1 signal at different operating temperatures of the display apparatus. FIG. 13 further shows a time sequence diagram of the S3 signal, a data signal DATA, a negative power supply voltage ELVSS, an initial voltage VINI, and a gate low-level voltage VGL1 at different operating temperatures. FIG. 13 shows a time sequence diagram of various signals in a j^{th} refresh cycle and a (j+1)^{th} refresh cycle, where each refresh cycle includes a non-light emission phase and a light emission phase. In an example, it is assumed that the display apparatus receives an instruction, status information in the j^{th} refresh cycle is the first value, and status information in the (j+1)^{th} refresh cycle is the second value. In this case, an amplitude of VGL1 decreases from VGL1_1 to VGL1_2. An operating temperature corresponding to the j^{th} refresh cycle is a low temperature T1, the S1 signal is output by the first gate drive circuit, and a low-level voltage of an S1 signal waveform is equal to a gate low-level voltage VGL1_1 received by the first gate drive circuit. An operating temperature corresponding to the (j+1)^{th} refresh cycle is a high temperature T2, the low-level voltage of the S1 signal waveform is equal to a gate low-level voltage VGL1_2 received by the first gate drive circuit, and an amplitude of VGL1_2 is lower than an amplitude of VGL1_1.

In addition, an amplitude of a data voltage remains unchanged, an amplitude of the negative power supply voltage also decreases from ELVSS_1 to ELVSS_2, and an amplitude of the initial voltage also decreases from VINI_1 to VINI_2, to further reduce power consumption of the display apparatus.

In some instances, the gate scanning signal is used to control the pixel circuit to write data. The status information includes the display brightness of the display apparatus, and display brightness corresponding to the first value is higher than display brightness corresponding to the second value.

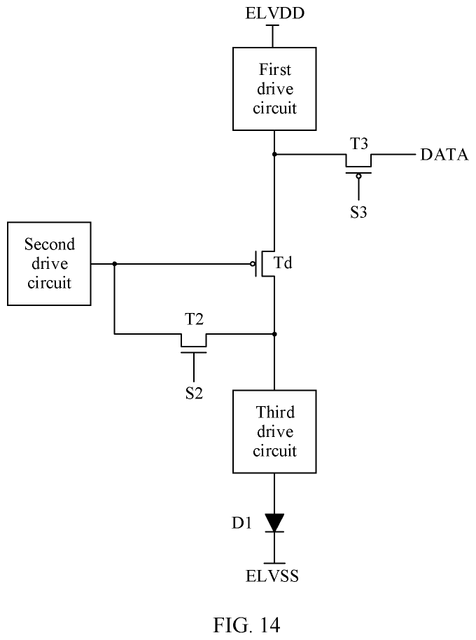

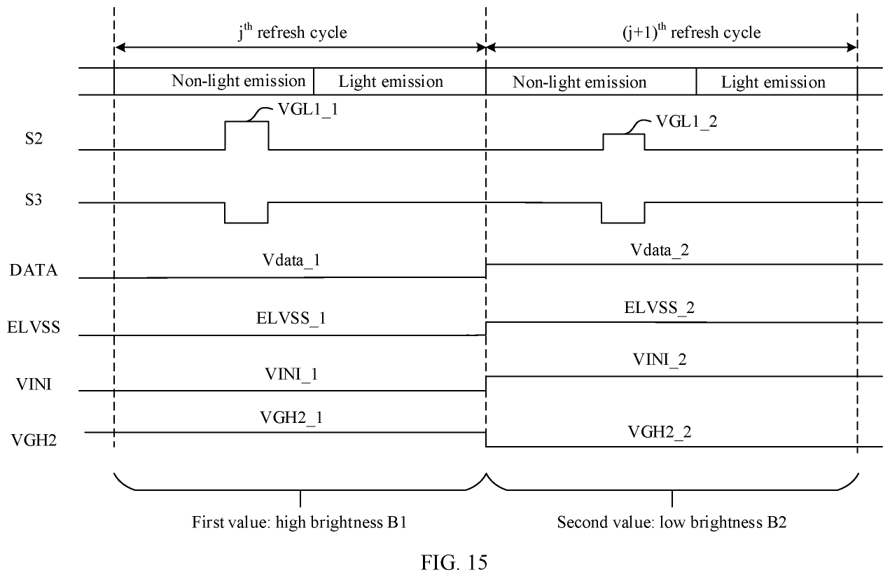

For example, an embodiment of this disclosure provides yet another pixel circuit. As shown in FIG. 14, the pixel circuit may include a first transistor (T2), a second transistor (T3), a drive transistor (Td), a light-emitting diode (D1), a first drive circuit, a second drive circuit, and a third drive circuit. A gate scanning signal of T2 is S2, and a gate scanning signal of T3 is S3. In addition, specific structures of the first drive circuit, the second drive circuit, and the third drive circuit are not limited in embodiments of this disclosure. The first transistor, the second transistor, and the drive transistor may be LTPS transistors or IGZO transistors, or may be transistors of another type. This is not limited in embodiments of this disclosure.

In different states of the display apparatus, amplitudes of a gate voltage of the S2 signal are different. For application in the pixel circuit shown in FIG. 14, FIG. 15 shows a time sequence diagram of the S2 signal at different display brightness levels of the display apparatus. FIG. 15 further shows a time sequence diagram of the S3 signal, a data signal DATA, a negative power supply voltage ELVSS, an initial voltage VINI, and a gate high-level voltage VGH2 at different display brightness levels. FIG. 15 shows a time sequence diagram of various signals in a j^{th} refresh cycle and a (j+1)^{th} refresh cycle, where each refresh cycle includes a non-light emission phase and a light emission phase. In an example, it is assumed that the display apparatus receives an instruction, status information in the j^{th} refresh cycle is the first value, and status information in the (j+1)^{th} refresh cycle is the second value. In this case, an amplitude of VGH2 decreases from VGH2_1 to VGH2_2. Display brightness corresponding to the j^{th} refresh cycle is high brightness B1, the S2 signal is output by the first gate drive circuit, and a low-level voltage of an S2 signal waveform is equal to a gate high-level voltage VGH2_1 received by the first gate drive circuit. Display brightness corresponding to the (j+1)^{th} refresh cycle is low brightness B2, the low-level voltage of the S2 signal waveform is equal to a gate high-level voltage VGH2_2 received by the first gate drive circuit, and an amplitude of VGH2_2 is lower than an amplitude of VGH2_1.

In addition, an amplitude of a data voltage also decreases from Vdata_1 to Vdata_2, an amplitude of the negative power supply voltage also decreases from ELVSS_1 to ELVSS_2, and an amplitude of the initial voltage also decreases from VINI_1 to VINI_2, to further reduce power consumption of the display apparatus.

In some instances, the gate scanning signal is used to control the pixel circuit to write data. The status information includes the operating temperature of the display apparatus, and an operating temperature corresponding to the first value is lower than an operating temperature corresponding to the second value.

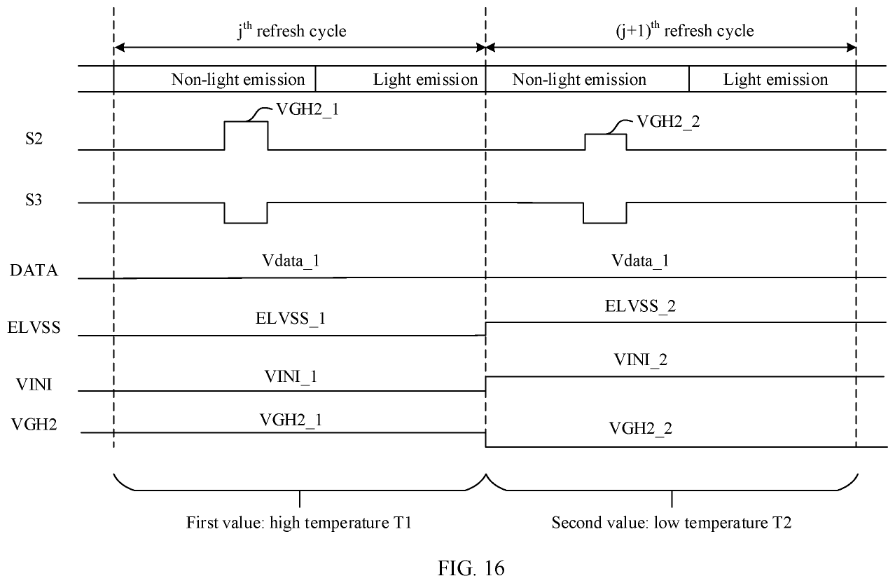

For example, at different operating temperatures of the display apparatus, FIG. 16 shows a time sequence diagram of the S2 signal. FIG. 16 further shows a time sequence diagram of the S3 signal, a data signal DATA, a negative power supply voltage ELVSS, an initial voltage VINI, and a gate high-level voltage VGH2 at different operating temperatures. FIG. 16 shows a time sequence diagram of various signals in a j^{th} refresh cycle and a (j+1)^{th} refresh cycle, where each refresh cycle includes a non-light emission phase and a light emission phase. In an example, it is assumed that the display apparatus receives an instruction, status information in the j^{th} refresh cycle is the first value, and status information in the (j+1)^{th} refresh cycle is the second value. An operating temperature corresponding to the j^{th} refresh cycle is a low temperature T1, the S2 signal is output by the first gate drive circuit, and a low-level voltage of an S2 signal waveform is equal to a gate high-level voltage VGH2_1 received by the first gate drive circuit. An operating temperature corresponding to the (j+1)^{th} refresh cycle is a high temperature T2, the low-level voltage of the S2 signal waveform is equal to a gate high-level voltage VGH2_2 received by the first gate drive circuit, and an amplitude of VGH2_2 is lower than an amplitude of VGH2_1.

In addition, an amplitude of a data voltage remains unchanged, an amplitude of the negative power supply voltage also decreases from ELVSS_1 to ELVSS_2, and an amplitude of the initial voltage also decreases from VINI_1 to VINI_2, to further reduce power consumption.

In some instances, the method for driving a display apparatus further includes: outputting a gate voltage to a second gate drive circuit in the plurality of groups of gate drive circuits based on the status information. The gate voltage is a third voltage when the status information is the first value, the gate voltage is a fourth voltage when the status information is the second value, an amplitude of the fourth voltage is less than an amplitude of the third voltage, and levels of the third voltage and the fourth voltage are opposite to levels of the first voltage and the second voltage.

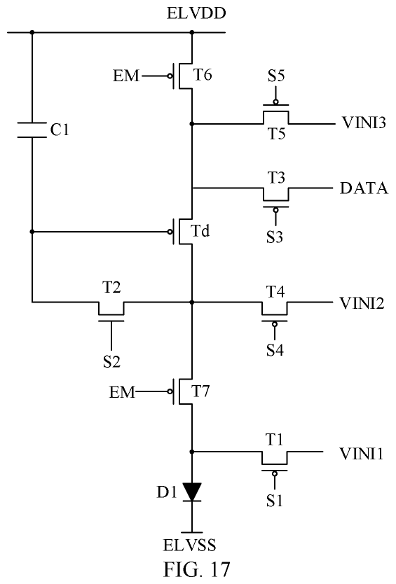

For example, an embodiment of this disclosure provides yet another pixel circuit. As shown in FIG. 17, the pixel circuit may include a capacitor (C1), a light-emitting diode (D1), a plurality of P-type transistors (T1, T3, T4, T5, T6, T7, and Td), and a plurality of N-type transistors (T2). A gate scanning signal of T1 is S1, a gate scanning signal of T2 is S2, a gate scanning signal of T3 is S3, a gate scanning signal of T4 is S4, a gate scanning signal of T5 is S5, and gate scanning signals of T6 and T7 are EM. One end of T1 is configured to input a first initial voltage (VINI1), one end of T4 is configured to input a second initial voltage (VINI2), one end of T3 is configured to input a data signal (DATA), and one end of T5 is configured to input a third initial voltage (VINI3).

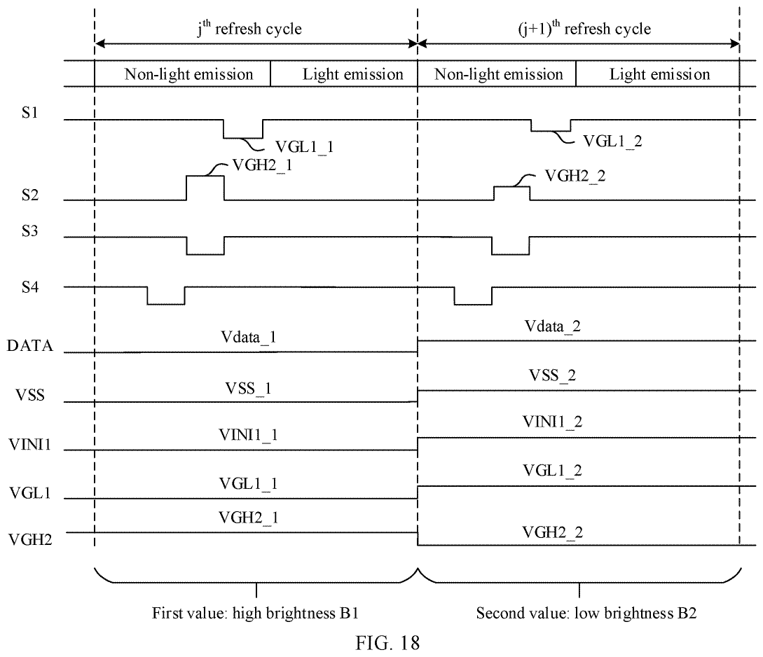

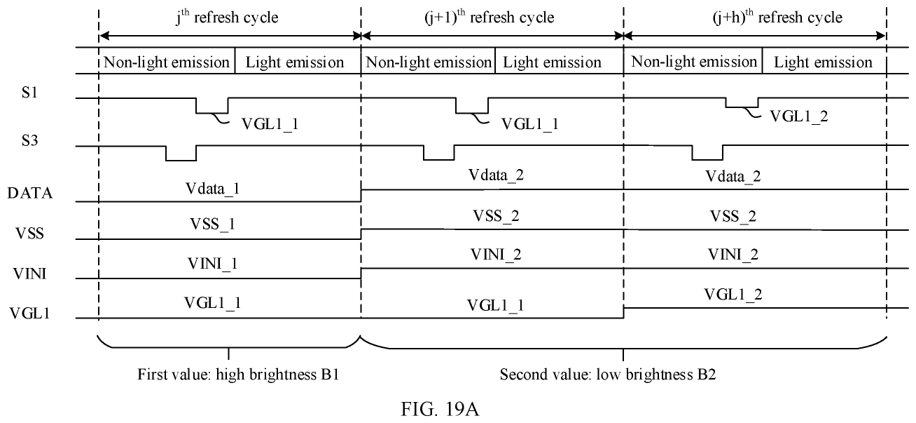

For application in the pixel circuit in FIG. 17, FIG. 18 shows a time sequence diagram of the pixel circuit. According to the method for driving a display apparatus provided in this embodiment of this disclosure, amplitudes of both the S1 signal and the S2 signal may be adjusted. FIG. 18 shows a time sequence diagram of various signals in a j^{th} refresh cycle and a (j+1)^{th} refresh cycle, where each refresh cycle includes a non-light emission phase and a light emission phase. In an example, it is assumed that the display apparatus receives an instruction, status information in the j^{th} refresh cycle is the first value, and status information in the (j+1)^{th} refresh cycle is the second value. In this case, an amplitude of VGL1 decreases from VGL1_1 to VGL1_2, and an amplitude of VGH2 decreases from VGH2_1 to VGH2_2. In an example, in high brightness B1, an amplitude of a high-level voltage of an S1 signal waveform is VGL1_1, and an amplitude of a low-level voltage of an S2 signal waveform is VGH2_1. In low brightness B2, the amplitude of the high-level voltage of the S1 signal waveform decreases from VGL1_1 to VGL1_2, and the amplitude of the low-level voltage of the S2 signal waveform decreases from VGH2_1 to VGH2_2.

In some instances, S1002 may include: outputting the gate voltage to the first gate drive circuit in the plurality of groups of gate drive circuits after waiting for at least one refresh cycle, and outputting the gate voltage to the second gate drive circuit in the plurality of groups of gate drive circuits after waiting for at least one refresh cycle.

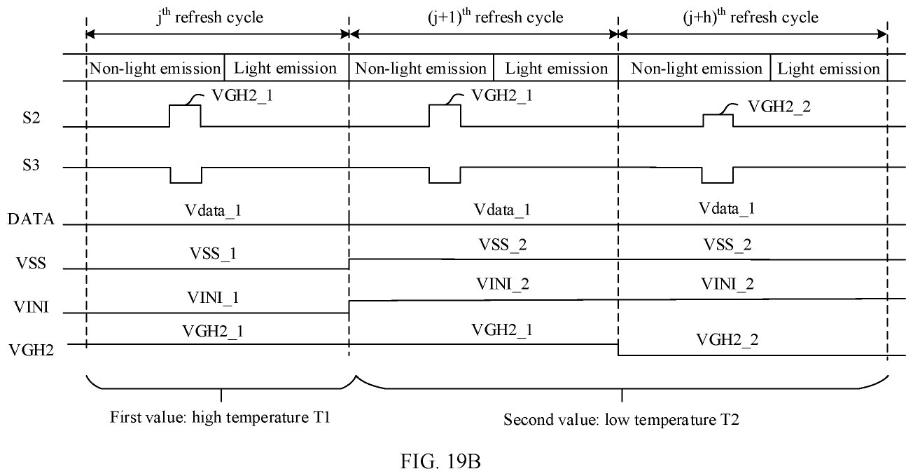

For example, as shown in FIG. 19A and FIG. 19B, FIG. 19A shows a time sequence diagram applied to the pixel circuit in FIG. 11, and FIG. 19B shows a time sequence diagram applied to the pixel circuit in FIG. 14. Because voltage switching may require time, the S1 signal may maintain, in the (j+1)^{th} refresh cycle, a voltage amplitude in the j^{th} refresh cycle, and then decrease from VGL1_1 to VGL1_2 in a (j+h)^{th} refresh cycle, where h is an integer greater than or equal to 2. For example, the S1 signal decreases from VGL1_1 to VGL1_2 in a (j+2)^{th} refresh cycle. In addition, the S2 signal may also maintain, in the (j+1)^{th} refresh cycle, a voltage amplitude in the j^{th} refresh cycle, and then decrease from VGH2_1 to VGH2_2 in the (j+h)^{th} refresh cycle, where h is an integer greater than or equal to 2. For example, the S2 signal may decrease from VGH2_1 to VGH2_2 in the (j+2)^{th} refresh cycle. Therefore, because the gate scanning signal changes after at least one refresh cycle, more time may be reserved for voltage switching, and flickering can be reduced.

An embodiment of this disclosure further provides a display apparatus. The display apparatus may include a peripheral drive circuit, a plurality of groups of gate drive circuits, and a plurality of pixel circuits. The peripheral drive circuit is configured to obtain status information of the display apparatus, where the status information includes display brightness and/or an operating temperature. The peripheral drive circuit is further configured to output a gate voltage to a first gate drive circuit in the plurality of groups of gate drive circuits based on the status information, and the first gate drive circuit is configured to output a gate scanning signal to a corresponding pixel circuit based on the gate voltage. The gate voltage is a first voltage when the status information is a first value, the gate voltage is a second voltage when the status information is a second value, and an amplitude of the second voltage is less than an amplitude of the first voltage.

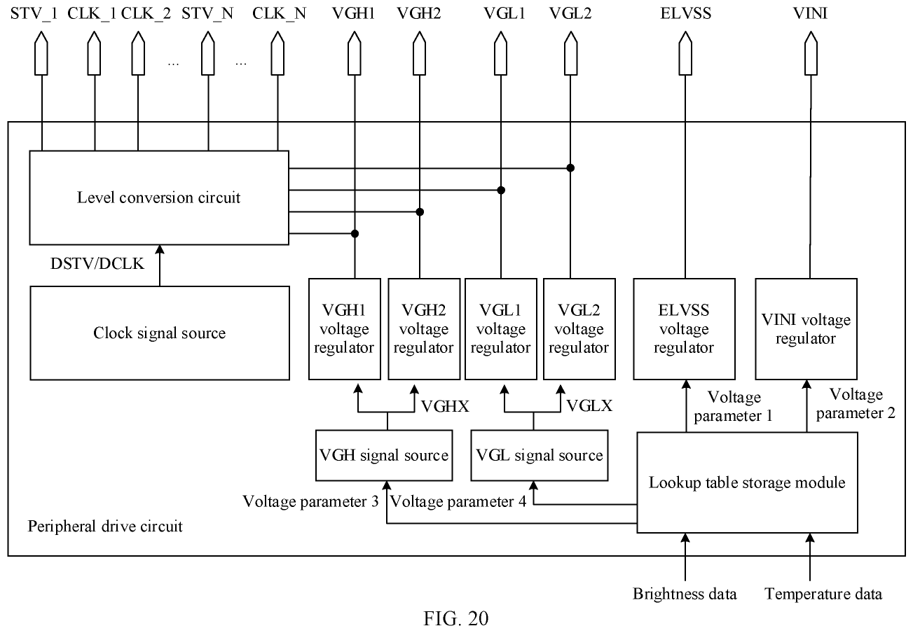

Based on the diagram of the structure of the peripheral drive circuit shown in FIG. 6, as shown in FIG. 20, FIG. 20 shows a diagram of a structure another peripheral drive circuit. A gate high-level voltage regulator may include a VGH signal source, a VGH1 voltage regulator, and a VGH2 voltage regulator, and a gate low-level voltage regulator includes a VGL signal source, a VGL1 voltage regulator, and a VGL2 voltage regulator. The peripheral drive circuit is further configured to: receive status data (for example, brightness data and temperature data), invoke voltage parameters, for example, a voltage parameter 3 and a voltage parameter 4, in a lookup table storage module, and send the voltage parameters to corresponding signal sources and voltage regulators. The VGH signal source may generate VGHX based on the voltage parameter 3, and the VGL signal source may generate VGLX based on the voltage parameter 4. Further, the VGH1 voltage regulator may generate VGH1 based on VGHX, the VGH2 voltage regulator may generate VGH2 based on VGHX, the VGL1 voltage regulator may generate VGL1 based on VGLX, and the VGL2 voltage regulator may generate VGL2 based on VGLX. In addition, the voltage parameter 3 and the voltage parameter 4 may be directly sent to the VGH1 voltage regulator, the VGH2 voltage regulator, the VGL1 voltage regulator, and the VGL2 voltage regulator, so that a voltage value of VGH or VGL is changed separately.

For example, the VGH1 voltage regulator, the VGH2 voltage regulator, the VGL1 voltage regulator, and the VGL2 voltage regulator may be voltage buck circuit modules. Therefore, absolute values of voltages of VGLX and VGHX are usually greater than that of voltages of VGL and VGH.

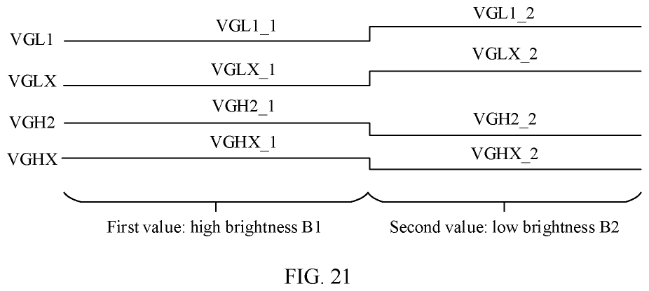

As shown in FIG. 21, FIG. 21 is a time sequence diagram of the peripheral drive circuit in FIG. 20. When the display apparatus is converted from high brightness B1 to low brightness B2, an amplitude of the voltage of VGLX decreases from VGLX_1 to VGLX_2, and an amplitude of a voltage of VGL1 decreases from VGL1_1 to VGL1_2. In addition, if the amplitude of the voltage of VGHX decreases from VGHX_1 to VGHX_2, an amplitude of a voltage of VGH2 decreases from VGH2_1 to VGH2_2.

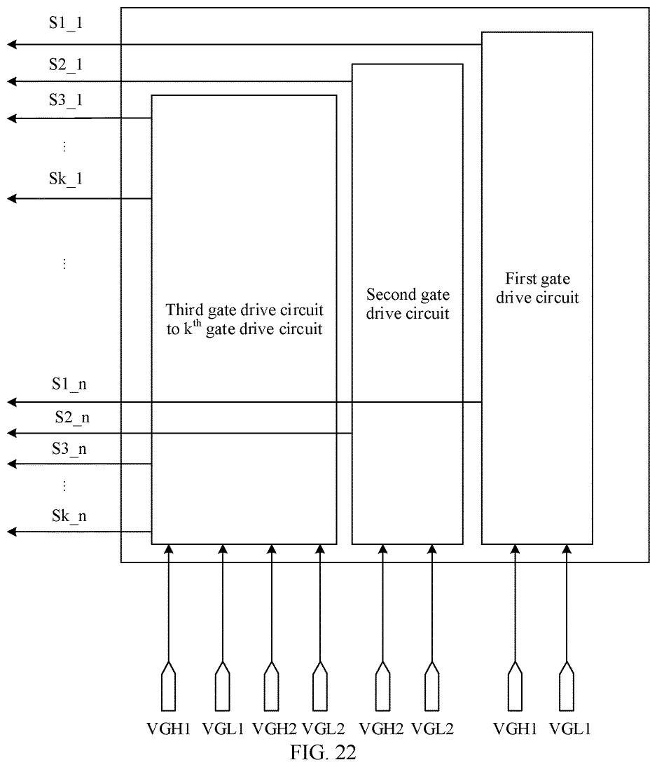

In an implementation, as shown in FIG. 22, FIG. 22 shows the peripheral drive circuit and the plurality of groups of gate drive circuits. The peripheral drive circuit is coupled to the plurality of groups of gate drive circuits through a plurality of voltage signal lines. The plurality of groups of gate drive circuits may be classified into a first gate drive circuit, a second gate drive circuit, a third gate drive circuit, . . . , and a kth gate drive circuit. The peripheral drive circuit may provide a plurality of groups of gate high-level voltages and gate low-level voltages with different voltage values to the gate drive circuits. For example, the peripheral drive circuit is coupled to the plurality of groups of gate drive circuits through VGL1, VGL2, VGH1, and VGH2. The VGL1 signal line may be coupled to both the first gate drive circuit and another gate drive circuit, and the VGH2 signal line may be coupled to both the second gate drive circuit and another gate drive circuit. The VGL1/VGH1 signal line is coupled to the first gate drive circuit, the VGL2/VGH2 signal line is coupled to the second gate drive circuit, and the VGL1/VGH1 signal line and the VGL2/VGH2 signal line are coupled to the third gate drive circuit to the kth gate drive circuit. In this connection manner, power consumption of the display apparatus can be further reduced.

It may be understood that a position of the gate drive circuit is not limited in embodiments of this disclosure. A position of the gate drive circuit of the display apparatus is not fixed. The gate drive circuits may be disposed on one or two sides of an active display area. The first gate drive circuit and the second gate drive circuit may be disposed on a same side or different sides of the active display area.

In some instances, the peripheral drive circuit is coupled to the first gate drive circuit in the plurality of groups of gate drive circuits through a first voltage signal line in the plurality of voltage signal lines, and the peripheral drive circuit is coupled to the second gate drive circuit in the plurality of groups of gate drive circuits through a second voltage signal line in the plurality of voltage signal lines.

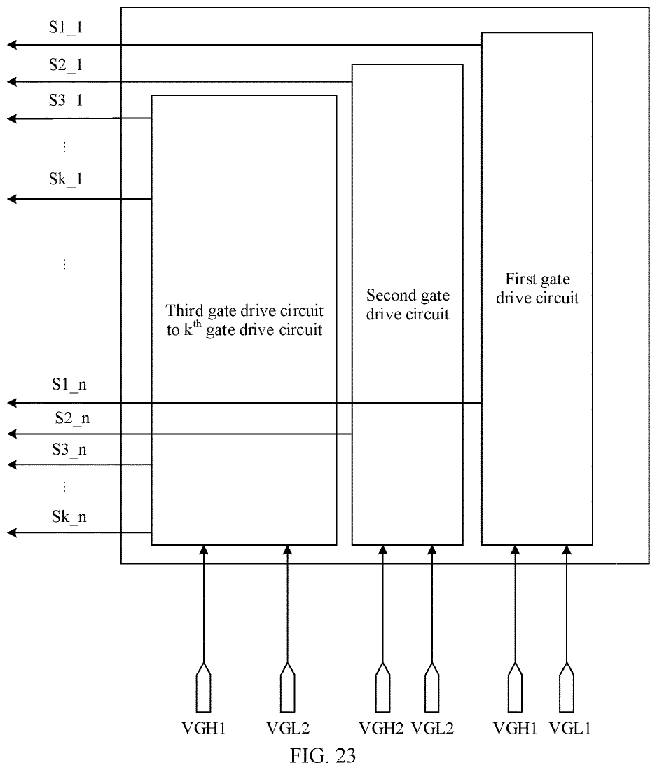

For example, as shown in FIG. 23, the first voltage signal line is VGL1 and the second voltage signal line is VGH2. The VGL1 signal line may be separately coupled to the first gate drive circuit, and the VGL2 signal line is coupled to another gate drive circuit. In addition, the VGH2 signal line may be separately coupled to the second gate drive circuit, and the VGH1 signal line is coupled to another gate drive circuit. The VGL1/VGH1 signal line is coupled to the first gate drive circuit, the VGL2/VGH2 signal line is coupled to the second gate drive circuit, and the VGH1/VGL2 signal line is coupled to the third gate drive circuit to the kth gate drive circuit. In this connection manner, power consumption of the display apparatus can be further reduced.

In some instances, the peripheral drive circuit is further coupled to a third gate drive circuit in the plurality of groups of gate drive circuits through the first voltage signal line, and is further coupled to a fourth gate drive circuit in the plurality of groups of gate drive circuits through the second voltage signal line. A gate scanning signal output by the third gate drive circuit is used to control the pixel circuit to emit light, and a gate scanning signal output by the fourth gate drive circuit is used to control gate reset of a drive transistor.

For example, the first voltage signal line may be coupled to both the first gate drive circuit and the third gate drive circuit, and the second voltage signal line may be coupled to both the second gate drive circuit and the fourth gate drive circuit. That is, it is assumed that the first voltage signal line is VGL1 and the second voltage signal line is VGH2. VGL1 may be coupled to a gate drive circuit that outputs a low-level gate scanning signal, and VGH2 may be coupled to a gate drive circuit that outputs a high-level gate scanning signal.

In some instances, the first voltage signal line or the second voltage signal line includes at least two metal layers, and the at least two metal layers are connected to each other through at least one connection hole.

For example, the first voltage signal line or the second voltage signal line may be formed by overlapping a plurality of metal layers, an inorganic layer is between adjacent metal layers, and the plurality of metal layers may be connected to each other at an appropriate position through connection holes, to implement electrical conduction. In this way, impedance on the first voltage signal line and the second voltage signal line can be reduced, impact of voltage switching on signal quality can be reduced, and a display effect can be improved.

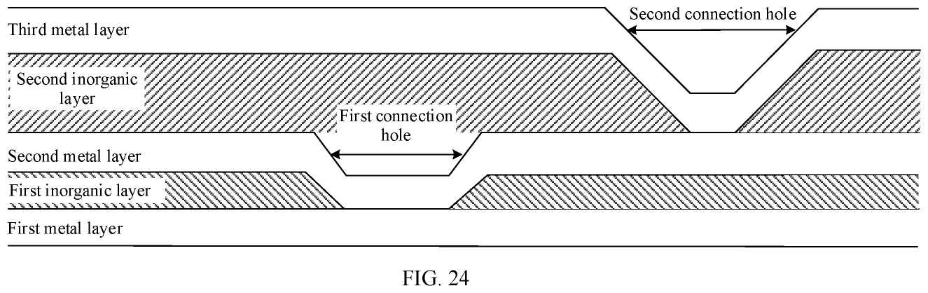

In an example, as shown in FIG. 24, FIG. 24 shows three metal layers and two inorganic layers, which are respectively a first metal layer, a first inorganic layer, a second metal layer, a second inorganic layer, and a third metal layer that are sequentially arranged. The first metal layer may be connected to the second metal layer through a first connection hole, and the second metal layer may be connected to the third metal layer through a second connection hole.

In an example, the metal layer may be three layers of titanium-aluminum-titanium metal or one layer of molybdenum metal, and the inorganic layer may be silicon nitride or silicon oxide.

An embodiment of this disclosure further provides a display device. The display device may include a processor and a display apparatus. The processor is configured to output status information to the display apparatus, where the status information includes display brightness and/or an operating temperature. The peripheral drive circuit is configured to obtain status information of the display apparatus. The peripheral drive circuit is further configured to output a gate voltage to a first gate drive circuit in the plurality of groups of gate drive circuits based on the status information, and the first gate drive circuit is configured to output a gate scanning signal to a corresponding pixel circuit based on the gate voltage. The gate voltage is a first voltage when the status information is a first value, the gate voltage is a second voltage when the status information is a second value, and an amplitude of the second voltage is less than an amplitude of the first voltage.

An embodiment of this disclosure further provides a computer storage medium. The computer storage medium stores computer instructions. When the computer instructions are run on an electronic device, the electronic device is enabled to perform the foregoing related method steps, to implement the method for driving a display apparatus in the foregoing embodiments.

An embodiment of this disclosure further provides a computer program product. When the computer program product is run on a computer, the computer is enabled to perform the foregoing related steps, to implement the method for driving a display apparatus by the electronic device in the foregoing embodiments.

In addition, an embodiment of this disclosure further provides an apparatus. The apparatus may be a chip, a component, or a module. The apparatus may include a processor and a memory that are connected to each other. The memory is configured to store computer-executable instructions, and when the apparatus runs, the processor may execute the computer-executable instructions stored in the memory, so that the chip performs the method for driving a display apparatus by the electronic device in the foregoing method embodiment.

The display apparatus, the display device, the computer storage medium, the computer program product, or the chip provided in embodiments is configured to perform a corresponding method provided above. Therefore, for beneficial effects that can be achieved, refer to the beneficial effects in the corresponding methods provided above. Details are not described herein again.

Based on the foregoing descriptions of the implementations, a person skilled in the art may understand that for the purpose of convenient and brief description, division into the foregoing functional modules is merely used as an example for illustration. During an application, the foregoing functions can be allocated to different functional modules for implementation based on a requirement, that is, an inner structure of an apparatus is divided into different functional modules to implement all or some of the functions described above.

In the several embodiments provided in this disclosure, it should be understood that the disclosed apparatus and method may be implemented in other manners. For example, the described apparatus embodiments are merely examples. For example, division of the modules or units is merely logical function division, and may be other division during an implementation. For example, a plurality of units or components may be combined or may be integrated into another apparatus, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may be one or more physical units, may be located in one place, or may be distributed on different places. Some or all of the units may be selected based on requirements to achieve the objectives of the solutions of embodiments.

In addition, functional units in embodiments of this disclosure may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a readable storage medium. Based on such an understanding, the technical solutions of embodiments of this disclosure essentially, or the part contributing to an example technology, or all or some of the technical solutions may be implemented in the form of a software product. The software product is stored in a storage medium and includes several instructions for instructing a device (which may be a single-chip microcomputer, a chip, or the like) or a processor to perform all or some of the steps of the methods described in embodiments of this disclosure. The foregoing storage medium includes any medium that can store program code, for example, a universal serial bus (USB) flash drive, a removable hard disk, a read-only memory (ROM), a RAM, a magnetic disk, or an optical disc.

The foregoing descriptions are merely specific implementations of this disclosure, but are not intended to limit the protection scope of this disclosure. Any variation or replacement readily figured out by a person skilled in the art in the technical scope disclosed in this disclosure shall fall within the protection scope of this disclosure. Therefore, the protection scope of this disclosure shall be subject to the protection scope of the claims.

What is claimed is:

1. A method comprising:
obtaining status information of a display apparatus, wherein the status information comprises one or more of a display brightness or an operating temperature; and
outputting a first gate voltage to a first gate drive circuit in groups of gate drive circuits based on the status information,
wherein the first gate voltage is a first voltage when the status information is a first value,
wherein the first gate voltage is a second voltage when the status information is a second value, and
wherein a first amplitude of the second voltage is less than a second amplitude of the first voltage.

2. The method of claim 1, wherein outputting the first gate voltage comprises further outputting the first gate voltage to the first gate drive circuit based on the status information and a preset correspondence between the status information and the first gate voltage.

3. The method of claim 1, wherein the status information comprises the display brightness, and wherein the display brightness is higher for the display brightness corresponding to the first value than for the display brightness corresponding to the second value.

4. The method of claim 1, wherein the status information comprises the operating temperature, and wherein the operating temperature is lower for the operating temperature corresponding to the first value than for the operating temperature corresponding to the second value.

5. The method of claim 1, wherein the status information comprises the display brightness and the operating temperature, and wherein an amplitude of the first gate voltage relates to the display brightness and the operating temperature.

6. The method of claim 1, further comprising outputting a second gate voltage to a second gate drive circuit in the groups of gate drive circuits based on the status information, wherein the second gate voltage is a third voltage when the status information is the first value, wherein the second gate voltage is a fourth voltage when the status information is the second value, wherein a third amplitude of the fourth voltage is less than a fourth amplitude of the third voltage, and wherein first levels of the third voltage and the fourth voltage are opposite second levels of the first voltage and the second voltage.

7. The method of claim 6, wherein outputting the first gate voltage comprises outputting the first gate voltage to the first gate drive circuit after waiting for at least one first refresh cycle; and
wherein outputting the second gate voltage comprises outputting the second gate voltage to the second gate drive circuit after waiting for at least one second refresh cycle.

8. A display apparatus comprising:
pixel circuits comprising a first pixel circuit;
groups of gate drive circuits comprising a first gate drive circuit; and
a peripheral drive circuit configured to:
obtain status information of the display apparatus, wherein the status information comprises one or more of a display brightness or an operating temperature; and
output a first gate voltage to the first gate drive circuit based on the status information, wherein the first gate voltage is a first voltage when the status information is a first value, wherein the first gate voltage is a second voltage when the status information is a second value, and wherein a first amplitude of the second voltage is less than a second amplitude of the first voltage,
wherein the first gate drive circuit is configured to output a gate scanning signal to the first pixel circuit based on the first gate voltage.

9. The display apparatus of claim 8, wherein the peripheral drive circuit is further configured to output the first gate voltage to the first gate drive circuit based on the status information and a preset correspondence between the status information and the first gate voltage.

10. The display apparatus of claim 8, wherein the status information comprises the display brightness, and wherein the display brightness is higher for the display brightness corresponding to the first value than for the display brightness corresponding to the second value.

11. The display apparatus of claim 8, wherein the status information comprises the operating temperature, and wherein the operating temperature is lower for the operating temperature corresponding to the first value than for the operating temperature corresponding to the second value.

12. The display apparatus of claim 8, wherein the status information comprises the display brightness and the operating temperature, and wherein an amplitude of the first gate voltage relates to the display brightness and the operating temperature.

13. The display apparatus of claim 8, wherein the first pixel circuit comprises a light-emitting diode (LED), wherein the LED comprises an anode, and wherein the gate scanning signal initializes the anode, controls the first pixel circuit to write data, or initializes the anode and controls the first pixel circuit to write data.

14. The display apparatus of claim 8, wherein the groups of gate drive circuits further comprise a second gate drive circuit, and wherein the peripheral drive circuit is further configured to output a second gate voltage to the second gate drive circuit based on the status information, wherein the second gate voltage is a third voltage when the status information is the first value, wherein the second gate voltage is a fourth voltage when the status information is the second value, wherein a third amplitude of the fourth voltage is less than a fourth amplitude of the third voltage, and wherein first levels of the third voltage and the fourth voltage are opposite second levels of the first voltage and the second voltage.

15. The display apparatus of claim 14, wherein the peripheral drive circuit is further configured to:
further output the first gate voltage by outputting the first gate voltage to the first gate drive circuit waiting for at least one first refresh cycle; and
further output the second gate voltage by outputting the second gate voltage to the second gate drive circuit after waiting for at least one second refresh cycle.

16. The display apparatus of claim 15, further comprising voltage signal lines coupling the peripheral drive circuit to the groups of gate drive circuits, wherein the voltage signal lines comprise:
a first voltage signal line coupling the peripheral drive circuit to the first gate drive circuit; and
a second voltage signal line coupling the peripheral drive circuit to the second gate drive circuit.

17. The display apparatus of claim 16, wherein the first voltage signal line or the second voltage signal line comprises at least two metal layers connected to each other through at least one connection hole.

18. A device comprising:
a processor configured to output status information comprising one or more of a display brightness or an operating temperature; and
a display apparatus comprising:
pixel circuits comprising a first pixel circuit;
groups of gate drive circuits comprising a first gate drive circuit; and
a peripheral drive circuit configured to:
obtain the status information from the processor; and
output a first gate voltage to the first gate drive circuit based on the status information, wherein the first gate voltage is a first voltage when the status information is a first value, wherein the first gate voltage is a second voltage when the status information is a second value, and wherein a first amplitude of the second voltage is less than a second amplitude of the first voltage,
wherein the first gate drive circuit is configured to output a gate scanning signal to the first pixel circuit based on the first gate voltage.

19. The device of claim 18, wherein the peripheral drive circuit is further configured to output the first gate voltage to the first gate drive circuit based on the status information and a preset correspondence between the status information and the first gate voltage.

20. The device of claim 19, wherein the status information comprises the display brightness, and wherein the display brightness is higher for the display brightness corresponding to the first value than for the display brightness corresponding to the second value.
